(19) United States
(12) Patent Application Publication
(10) Pub. No.: US 2003/0144922 A1
(43) Pub. Date: Jul. 31, 2003

(54) Method and system for transactions between persons not sharing a common language, currency, and/or country

(76) Inventor: John Paul Schrantz, Maple Grove, MN (US)

Correspondence Address: GARY CARY WARE & FREIDENRICH LLP, 1755 EMBARCADERO ROAD, PALO ALTO, CA, 94303-3340, US

(21) Appl. No.: 10/351,238

(22) Filed: Jan. 24, 2003

Related U.S. Application Data
(60) Provisional application No. 60/352,331, filed on Jan. 28, 2002.

(51) Int. Cl. G06F 17/60

(52) U.S. Cl. 705/26

(57) ABSTRACT

A method and system for enabling person-to-person transactions between persons not sharing a native language, currency, and/or country, is provided. Person-to-person commerce is facilitated by providing sellers with the ability to input condition information, product attribute information, and by providing buyers with the ability to input seller transaction performance rating information, in each case through a standardized structured form that assigns coded designators to the information so that it can be selectively displayed to a buyer in a different language from the language in which the information was input. When the seller lists an item for sale, he completes a survey form specific to that product, describing the condition and any special attributes of the item. This information is then stored in the system as a series of numeric codes, which can then be used to display the information in different languages. The cost of shipping an item between any two places is automatically calculated using shipping tables maintained by the operator of the system and a catalog of data on products containing information such as the weight, dimensions, and the tax type of the product. The tax applicable to the sale and on shipping is also automatically calculated, taking into account the locations and tax status of the buyer and seller, and the type of product being sold. Automatic conversion between different currencies allows buyers to pay in a currency different from the currency in which the seller will be reimbursed. Automated, standardized, rules-based communications between buyer and seller in their respective languages are used to facilitate communications about transactions, reduce the requirements for customer service intervention, and resolve disputes. When the buyer completes a transaction, he completes a survey form (generic or specific to that transaction type), describing the aspects of the transaction performance by the seller. This information is then stored in the system as a series of numeric codes, which can then be used to display the information in different languages.

### BACKGROUND OF THE INVENTION

The present invention relates generally to e-commerce transaction systems, and more particularly to a centralized exchange system for creating a marketplace to buy and sell all types of products and services, without regard to the language of the buyer and seller, the location of the buyer and seller, or the currency used by the buyer to buy goods and services from the seller.

Over the past several years, it has become increasingly popular for Internet users to buy and sell goods in a decentralized manner known as consumer-to-consumer (C2C) or person-to-person (P2P) commerce. In the P2P model, rather than buying from a single retailer that maintains its own warehouse and logistics facilities, the operator of an exchange aggregates many buyers and sellers, who buy from and sell to each other much as stocks are traded on NASDAQ. Ebay (http://www.ebay.com) is a well known one of these P2P marketplaces, and it primarily uses an auction model to generate transactions between buyers and sellers.

In the P2P auction model, the seller goes to the site of the operator, enters a description of the item to be auctioned, and, optionally, sets a reserve price or a buy now price for the auction. Buyers then may bid on the item for a specified period of time or elect to purchase the item at the buy now price, and at the end of the auction, the seller receives the e-mail address of the winner of the auction. The buyer and seller at that point may complete the transaction themselves by e-mail or telephone. This may include the manual determination of shipping charges and any applicable tax to arrive at a total cost to the buyer, and the arranging for payment and shipment. After the conclusion of a transaction, the buyer and seller typically have the opportunity to rate the other party in the transaction, where they may select positive, neutral or negative as the characterization of their comment or select a number of stars to as a rating, and can leave a free form text comment about the experience with the other party in the transaction.

Another variation of the P2P model is the fixed-price, fully-mediated P2P systems, using standard product catalogs rather than the free-form listing format of the auction sites. A well known one of these systems is Half.com (see http://www.half.com), which is owned and operated by eBay. These fixed-price P2P systems are an improvement over the auction systems in that they may take payment directly from the buyer, and estimate shipping costs for the goods in the order (albeit usually in a simplistic “flat price per unit” manner). The seller typically enters condition information for used goods, at the time he lists his goods for sale, as free-form text, which by definition is difficult or impossible to display in different languages. This condition information is usually displayed to the buyer when he is reviewing items displayed on the system for purchase. This approach reduces the necessity of the buyer communicating directly with the seller to complete the transaction. Following a completed transaction in such a fixed-price, fully mediated P2P system, buyers typically have an opportunity to rate the seller where they may select positive, neutral or negative as the characterization of their comment or select a number of stars to as a rating, and can leave a free form text comment about the experience with the other party in the transaction. In such a fixed-price, fully mediated P2P system, the buyer may choose items to buy that are displayed on the system, put them in a “shopping cart”, and place orders for the items by providing payment information and a shipping address to the operator of the system (but not to the seller). The operator of the system may then provide the shipping information for the buyer, and a description of the items ordered by the buyer to the seller(s) of the items contained in the buyer's order. The seller can then ship the items directly to the buyer without ever having communicated directly with the buyer. Another variation of the P2P model is P2P systems that trade in services such as expert advice. A noteworthy example of such a system is described in U.S. Pat. No. 5,862,223, issued to Walker et al.

To date, however, person-to-person and e-commerce systems, in general, have been limited in the scope of possible buyers and sellers that can use the system. In the case of on-line P2P auction systems, a potential buyer must be able to understand the free form description of the item (which was entered by the seller in a language). In such P2P auction systems, the buyer should be able to understand not only the general or overall performance rating of a seller, but also the specific comments about the actual performance of the seller in key aspects of historical transactions, in order to have confidence in the ability and propensity of the seller to complete a potential transaction. In such P2P auction systems, when a buyer wins an auction, he/she may communicate directly with the seller to complete the transaction. If the seller and buyer speak different languages, there may be misunderstandings about the description of the item, about the trustworthiness or behavior of the seller (as a result of natural language free form text comments about the seller), or about the completion of the transaction itself. In addition, if the buyer wants to pay using a payment method not accepted by the seller, this causes problems. Thus, the number of buyers for a particular seller's item may be limited to the number of buyers that speak the seller's language well enough to complete the transaction.

In the case of fixed-price, fully mediated P2P systems, the limitations are similar to those of P2P auction models, but because the transactions on such a site are fully mediated, many transactions actually become impossible. In a fully mediated transaction, the seller has no direct contact with the buyer. Thus, the system itself may be required to calculate the applicable tax, obtain the correct shipping information to the buyer's location, and inform the buyer of any important item condition information in the buyer's language. The fixed-price, fully mediated P2P systems currently in existence either do not calculate taxes on sales by sellers or calculate them only for sales to a limited geographical area, do not calculate shipping rates for all possible destination addresses, or do so for only a limited number of products in the system's catalog (and on a simplistic gross basis), do not allow buyers to pay in a currency other than that in which the seller will be reimbursed, and importantly, do not enable condition information or seller rating/performance information to be input in a structured, language independent format that would enable efficient and accurate conversion to languages other than the language in which such information was input, other than broad or gross description of an item's general or overall condition or a simplistic point or “star” system for rating the performance of sellers in previous transactions. (Note: one drawback with the prior use of condition information is that while, for example, Amazon asks the user to select between 4 overall quality ratings (Like New, Very Good, Good, Acceptable) and provides definitions of those ratings, Amazon does not capture any specific information about the actual properties of the item other than relying on the user to select a broad condition rating. Thus, systems like Amazon can only display “Like New” category label in multiple languages instead of having more specific characteristics identified for user information input).

Thus, in the case of fixed-price, fully mediated P2P systems, sellers are generally limited to transacting business only with buyers that reside in the same country or geographical region as the seller, that pay in the same currency as that used by the seller, that may be under the same tax jurisdiction as the seller, that understand the seller's language well enough to understand the condition information as input by the seller, and that understand the rating and performance information about that seller collected and displayed by the operator of the system well enough to have confidence in the ability and propensity of the seller to complete a potential transaction. The limitations on the utility of condition information (beyond the broad categorization) that can be accurately displayed in multiple languages could substantially limit the completeness or accuracy of the description of the item to be listed for sale. Similarly, the limitations of a point-based, star-based, or other simplistic seller performance rating system in combination with free form text language-dependent comments could substantially limit the ability of a buyer to develop the confidence required to enter into a transaction with a given seller.

### SUMMARY OF THE INVENTION

These and other problems encountered with known person-to-person transaction systems are overcome by the present invention. The invention enables condition and feature information for goods and services to be entered into the system in any language, displayed in any of a number of other different languages, enables buyers and sellers to be notified of the status of a transaction in their native language during every phase of the life-cycle of the transaction, even if these languages are different, allows the buyer to pay in a currency other than that which will be received by the seller as reimbursement, accurately calculates tax due the seller, accurately calculates shipping charges for the seller, and removes the need for the buyer and seller to communicate directly at any stage in the transaction.

The invention affords a network-based transaction method and system hosted on a website by an operator for facilitating the cross-border and/or cross-currency and/or cross-language person-to-person transaction involving the sale of goods and/or services. It should be appreciated that a “person” may be a person, partnership, corporation, legal entity, and the like. In accordance with the various aspects and features of the invention, sellers are registered to collect the tax status of the seller (whether or not the seller is a sales-tax or value-added-tax collecting entity), the exact address from which the seller will ship, (used to calculate shipping and tax for the buyer), the seller's preferred language, the seller's preferred reimbursement currency, and the seller's name and corporate registration information (if seller is registering as a corporation).

Next, buyers are registered and information is collected such as the name of the buyer, the tax status of the buyer, the buyer's preferred language, the buyer's preferred payment currency, and the exact shipping address of the buyer, which is used to calculate shipping and tax.

Sellers list items for sale based on a pre-determined catalog of products maintained in a database by the system. The catalog may include the size, type, weight, and other important characteristics of all the products in the catalog. Sellers also input information about the condition (and characteristics, if appropriate) of the items they list for sale using a standardized form (in the seller's preferred language) provided by the system appropriate to the type of product they are selling. The use of catalogs and product trees, enables the system operator to develop product type specific standardized forms to capture the most relevant condition or characteristic information for a given product type, ensuring maximum utility of such information. Condition information entered by the seller in standardized form is converted to code numbers and stored in the database. Weightings can then be applied to such code numbers to display this condition information in natural language form in different languages, and also to determine the displayed condition grouping for the item, e.g., “Good”, “Very Good”, “Average”, etc. In addition, storing the code numbers for specific condition or characteristic information in the database enables significantly more accurate and advanced searching capabilities, potentially enabling the user to specify several specific parameters to limit the search, rather being limited to choosing a broad condition “category” such as Very Good.

Items of interest to the buyer are displayed by matching a product description, including information about the seller selling that item, the price of the item with tax, the shipping cost to the buyer, the total price delivered to the buyer, and notes on the condition of the item. Information is displayed in the language and preferred currency of the buyer. Moreover, the display of items may be restricted based on the buyer's locality to allow sellers to limit the geographical area in which their items will be listed for sale and made available for purchase by buyers.

The invention automatically converts prices into the local currency of the buyer, or any other specified currency, using currency exchange tables which may optionally be linked to real time data sources, to enable the buyer to view and buy items in his own preferred currency, regardless of the currency in which the seller listed the items for sale, or in which the seller will be reimbursed for any sale.

The invention calculates the shipping cost required to ship the items from the seller to the buyer, taking into account such factors as the shipping method chosen by the buyer, the weight and/or dimensions of the items being shipped, the applicable tax, and restrictions, if any, on shipping certain types of goods. Additionally, the invention calculates the tax due on the transaction, taking into account the tax payer status of the buyer and seller, the location of the buyer and seller, the type of product being sold, and other relevant factors.

The invention also takes payment for the items sold on the site on behalf of the seller in the currency preferred by the buyer or in other currencies as required by the chosen payment method or by the operator of the invention. Payment options include electronic payment methods, cash payment, and payment by check, among others. Additionally, the invention provides the seller in the seller's language with the shipping information required to complete the transaction. The invention provides, in the buyer's language, confirmation of the contents of the buyer's order and may confirm the receipt of items by the buyer, through e-mail or other notification methods.

The invention transfers funds to the seller for the items sold, in the seller's selected currency (which may be limited by the operator of the system), regardless of the currency in which the buyer paid for the items; and provides customer support to both buyers and sellers, including enabling the automated electronic communication between buyer and seller about specific transaction related issues, enabling transaction-specific inquiries to occur between buyers and sellers in different languages without requiring intervention by an operator of the invention, and facilitating the resolution of disputes that may remain between buyers and sellers. Examples of such automated, language independent communications would include a buyer indicating (e.g. by clicking on a link) that he/she has not received the items reportedly sent by the seller, based on which the invention would send an electronic communication to the seller (in the preferred language of the seller) explaining that the buyer had not received items X, Y and Z, and asking the seller to chose from a list of explanations (e.g. by clicking on one of a number of links) or to enter specific information about the shipment (such as a shipping date, tracking number, and the like), the results of which would then result in the invention sending an electronic communication to the buyer (in the buyer's preferred language) with the information from the seller about the status of the shipment of the items. The invention can use rule sets to determine based on these automated communications whether human intervention by a customer service representative would be appropriate or whether additional actions should be taken (such as sending an automated inquiry to a postal carrier about a delayed shipment).

Furthermore, the computer-based method and system of the invention allow sellers to list items based on a product catalog maintained in a database by the system, and allow sellers to list items on the site by way of a bulk upload of pricing, availability and condition information.

An additional feature allows a seller to specify that all or a portion of payments for sales of all or specific items be made to a third party. This allows, among other uses, for an individual to sell an item on the system and have all or a portion of the payment for the item go to the individual's favorite charity (see e.g., FIG. 8), or for an entity to sell an item on the system and have all or a portion of the payment for the item go to an affiliated or parent entity.

Advantageously, the method and system of the invention also allow buyers to input feedback information about the quality of service provided by the seller and about specific aspects of the transaction using a standardized form (in the appropriate language for the buyer) that can be customized by the operator of the system to capture performance information and metrics about specific types of transactions, items, shipping methods, and the like in a language independent fashion, such that the performance information entered by the buyer in standardized form is converted to code numbers and stored in the database. The information is thus converted to a series of numbers and weighting codes that can then be used to display this rating information and specific transaction performance metrics in different languages, including the buyer's preferred language.

Sellers may also be reimbursed for sales in the form of store credit or gift certificates to be used to pay for future purchases made on the system.

According to one aspect of the present invention, a network-based system for executing transactions between sellers and buyers for the sale of products is provided. The system includes a first portion for receiving item information from a seller regarding an item offered for sale in any one of a plurality of different languages selected by the seller; a second portion for providing the item information to a buyer in any one of a plurality of different languages selected by the buyer; and a third portion for receiving payment information for the item from the buyer in any one of a plurality of different currencies selected by the buyer, and for facilitating payment to the seller in any one of a plurality of currencies selected by the seller. The system may also include a fourth portion for facilitating communication between the buyer in any one of a plurality of different languages selected by the buyer and the seller in any one of a plurality of different languages selected by the seller for the purpose of communicating about the a transaction; and a seller-ratings portion for receiving transaction performance information from a buyer regarding the performance of a seller in a transaction in any one of a plurality of different languages selected by the seller, and for providing historical performance information about specific sellers to a buyer.

According to another aspect of the present invention, a method is provided for executing transactions between sellers and buyers for the sale of products. The method includes the steps of: receiving item information from a seller regarding an item offered for sale in any one of a plurality of different languages selected by the seller; providing the item information to a buyer in any one of a plurality of different languages selected by the buyer; receiving payment information for the item from the buyer in any one of a plurality of different currencies selected by the buyer; and facilitating payment to the seller in any one of a plurality of currencies selected by the seller.

As used herein, the word “product” may refer to any good or service, recurring sales (such as the purchase of a subscription to a periodical), or rental of any good or service. As used herein, the words “item” or “product item” refer to a specific manifestation (logical or physical) of a product (for example, a seller may have multiple copies of a particular music Compact Disc, each one of such copies would be an item of the same product), where for new items of a product with identical features, such items may be considered identical, and where for used items of a product with identical features, such items may be considered unique. “Operator” and “coordinator” refer to the person or entity operating the e-commerce site, which would normally be a web system on the Internet. “Site” refers to any system maintained and operated by the operator or coordinator.

The invention will be now described, by way of example and without limitation, with references to the accompanying drawings; and other objects, features and advantages of the invention will be apparent from this detailed disclosure and from the appended claims.

### BRIEF DESCRIPTION OF THE DRAWINGS

FIG. 1 is a diagrammatic view of a translation system according to the invention;

FIG. 2 is a preferred example of the information provided to the buyer when selecting items for purchase;

FIG. 3 is a diagrammatic view of the relationship between orders, order transactions, and order transaction items;

FIG. 4 is a diagrammatic view showing the use of data trees in the invention;

FIG. 5 is a flowchart illustrating a process for calculation of taxes in the invention;

FIG. 6 is a diagrammatic view of the relationship between shipping methods and shipping rates;

FIG. 7 is a flowchart illustrating a process for the calculation of shipping charges;. FIG. 8 is a flowchart of a process of a seller selling an item for the benefit of charity;

FIG. 9 is a diagrammatic view of an example of key-value pairs, which may be employed by the invention;

FIG. 10 is a diagrammatic view of a sample tax calculation;

FIG. 11 is a flowchart of a process of a seller listing an item for sale using the web site interface of the system; and

FIG. 12 is a diagrammatic view of a sample shipping calculation.

### DETAILED DESCRIPTION OF THE EMBODIMENTS

The invention is particularly applicable to an e-commerce system and method for sales transactions and the like, and will be described in that context. In the preferred embodiment, the system and method are implemented on a global communications or computer network. Particularly, the system and method may comprise a “Web site,” that may be implemented by at least one conventional computer system (e.g., including hardware, software and firmware components) that is operatively and communicatively coupled to a global computer network (e.g., the Internet), and that may be selectively and remotely accessed by users of the network. It will be appreciated, however, that this is illustrative of only one utility of the invention and that the invention may be used for other kinds of network systems, such as wireless networks and the like.

Furthermore, where certain elements of the present invention can be partially or fully implemented using known components, only those portions of such known components that are necessary for an understanding of the present invention will be described. Detailed descriptions of other portions of such known components will be omitted so as not to obscure the invention. Moreover, while the embodiments described herein are in reference to a Web interface system, the present invention is not limited to these exemplary contact embodiments, but can be practiced with any type of suitable environment and/or interface.

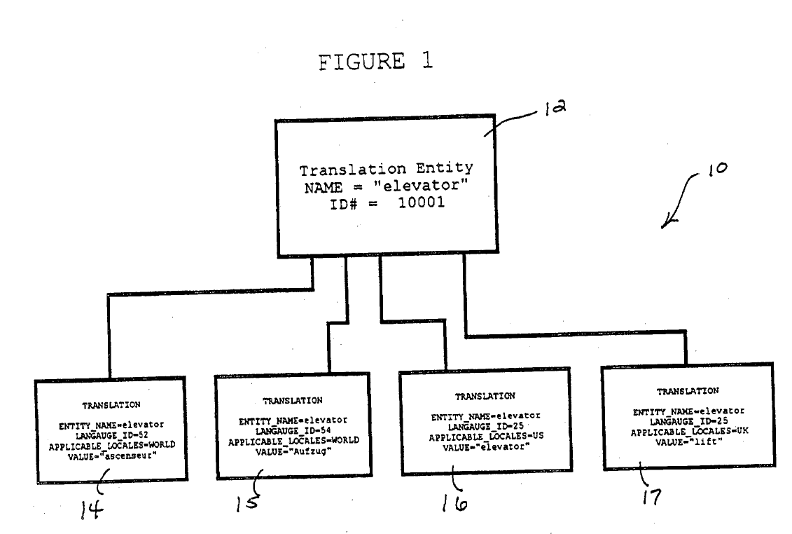

FIG. 1 shows one embodiment of a translation system 10, according to the present invention. The translation system 10 may include translation entities 12 and translations 14-17, and may be used to provide for the display of information related to transactions in any of a large number of different languages. Additionally, translations may be marked with an “applicable locale” tag indicating geographical areas of usage to allow for differences in regional usage within a given language.

To add a translation to the system, a translation entity 12 is created. The translation entity may have a numeric ID code and an alphanumeric identifier. An optional description (which need not be displayed to end-users) can also be provided to facilitate finding translation entities. Translation entities can represent an abstract concept, formed of single words, phrases, sentences, or even entire documents.

Once a translation entity has been created, translations 14-17 can be created for any languages that the operator of the system wishes to support. A translation may comprise the code for the corresponding translation entity, an ID code number for the target language of the translation, a locale identifier indicating the applicable locale for the translation, the translation itself, and optionally, a URL or other link if the translation will be hyper-linked to other data when displayed by the system.

Retrieving the proper translation for a given language requires only the ID code for the target translation language, and the numeric or alphanumeric code for the translation entity for which a translation is desired. If, for example, Czech is language code 19 and the alphanumeric code for the translation entity that represents the word “help” is “HELP”, translation requires retrieving the record from a translation table that has alphanumeric code “HELP” and applying the language code 19 to return the Czech word “pomoc”.

The translation system may be used extensively in the invention to provide translations for, inter alia, movie titles, product features, condition information, seller ratings, help files, transaction information and any other information which it is desired to display in different languages.

Below is an example of an HTML/XML page constructed using the system's translation system. This example prints the word “help” to a display screen in the Czech language. If 25 is the language code for English, substituting 25 as the language code for code 19 would cause the word “help” to be displayed to the screen in English.

Example of HTML/XML Page constructed with Translation System

<HTML>

<HEAD>

</HEAD>

<BODY>

<TRANSLATION NAME=“HELP” LANGUAGE=“19”>

</BODY>

</HTML>

The invention organizes and stores data in data structures comprised of data objects. Many of the data structures used in the invention may be hierarchical structures known as “data trees”. The use of data trees allows attribute information, such as tax rates, to be applied to an entire set of products or locales without having to define the tax rates for every product and locale. These data trees may be similar to family trees, with the exception that each child preferably has only a single parent.

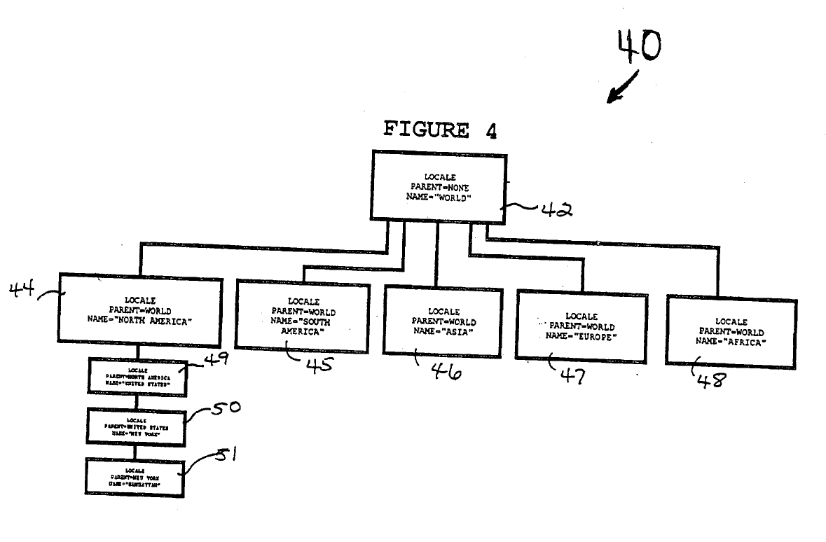

As shown in FIG. 4, “Locales” are preferably defined by beginning at the top of a data tree 40 named “World” 42. World is a parent (or grand-parent, or great-great grandparent, etc.) of every other locale in the system, as it is at the top of the tree and all other locales descend from it, as shown in FIG. 4. Below “World”, the tree hierarchy comprises continents 44-48, major country groupings (not shown, e.g., NAFTA, the European Union, countries 49 (such as the United States), and so on down to the level of neighborhoods or even streets if desired. Other data sets that may be defined in the same way as locales include product groups and genres. For example, every product group, e.g., televisions, is descended from an abstract parent “Product Group,” and every item, e.g. a seller's copy of a Compact Disc, may be descended from a “Product”.

By defining locales in this way, shipping or tax rates can be defined at the highest possible locale level to which they apply, and this definition will thus apply to all the lower level locales that are descended from that locale, without having to define the tax or shipping rate for every lower locale in the system. For example, a shipping method that is valid for any items being shipped from New York (NY) State 50 by definition applies to items being shipped from Manhattan 51, as Manhattan is below NY State in the locale tree. Assuming that the cost of sending first class business mail is the same for all addresses in NY State, the cost of sending first class mail may be defined at the NY State level, and need not be defined for any lower level of the children of the NY State locale, because those locales would inherit information about shipping costs from the parent NY State locale.

A key component of the invention addresses a limitation of current systems, i.e., the inability of a seller to input specific and accurate condition and feature information about an item the seller wishes to sell in a language-independent fashion, and have such information displayed to potential buyers in a number of different languages. The ability to enter language-independent condition information is especially important in cases where the item is either used or has some special characteristic not shared by other items of the same product. A good example of an item that might possess special characteristics is a personal computer. Personal computers, even those with the same manufacturer's model number, often vary widely in terms of components (some have additional RAM, or a larger hard drive, or a DVD player in place of the CD-ROM, etc.). In the case of second-hand items or other used items such as compact discs, it is important that the seller be able to describe its condition, e.g., “average”, and indicate why he rated the item “average”. It may be because the compact disc is slightly scratched, or because the liner notes are missing. This information must be conveyed to the buyer in the buyer's native language if the buyer is to make an informed purchasing decision.

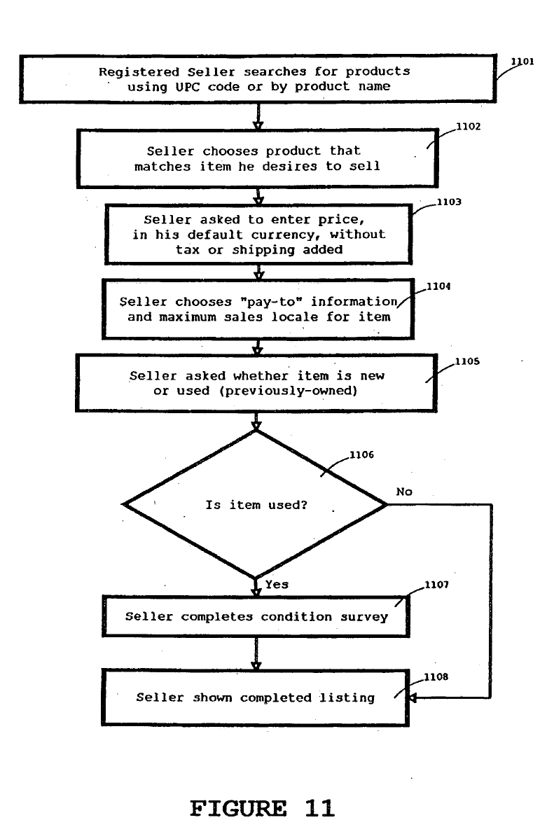

The process for listing an item on the transaction site of the invention through a web site interface will now be described. A flowchart showing a process for listing an item for sale on the system using the web interface is shown in FIG. 11. Initially, the seller will be asked to identify the product he wishes to sell. The seller may identify the item as a product by entering the product's UPC or EAN number, and/or by entering its model number, or by searching a system database for the product by name or manufacturer (step 1101). The system may contain a table listing the name, model number, and UPC/EAN code of every product that can be sold through the system. Once the seller has identified the product he wishes to sell (step 1102), he may next enter the selling price that will be listed for the item (step 1103) (the system may display historical and current price information to assist the seller in determining the desired selling price), the “pay-to” information for the item if the all or a portion of proceeds of the sale will be paid to a person other than the seller (e.g., a charity as shown in FIG. 8), and the maximum sales locale or region, if any, in which this item will be for offered sale (step 1104). If the seller does not choose a maximum sales locale, the seller's sales locale may be used as a default sales locale.

Next the seller may be prompted to complete a survey form to indicate to the system the condition and features of the item to be sold (step 1105). If the item were indicated to be brand-new condition, the seller would not be asked to describe the item's condition (step 1106). If the item is indicated to be in a used condition, or is new but has some special characteristic, e.g., extra RAM in the case of a PC, the seller may complete the condition and feature survey form in the seller's preferred language (step 1107). The condition and feature survey for information for a product is based on the product's “product group”, as described above in connection with the discussion of data trees, and may be customized by the operator of the system to capture information relevant to that particular “product group” in standardized form. The seller is then shown the completed listing (step 1108).

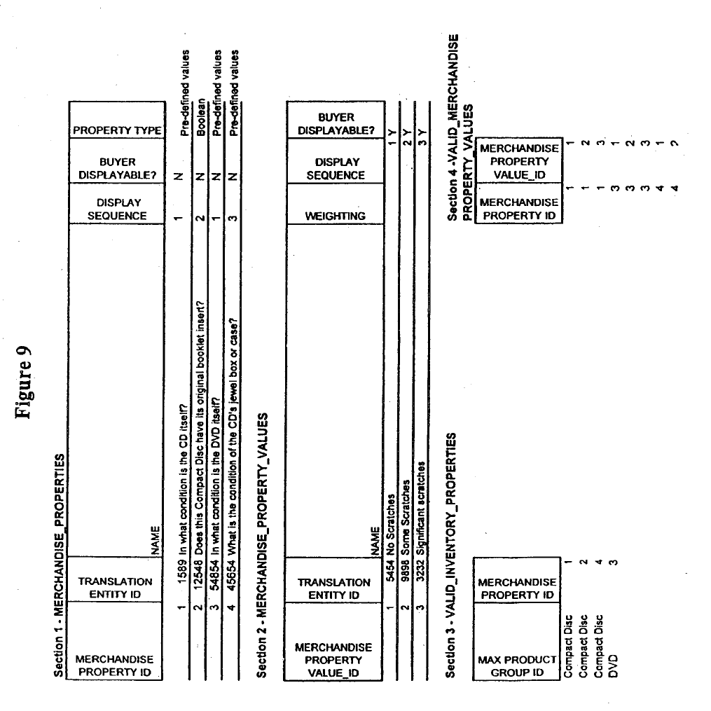

Some examples of tables that may be used to construct the inventory condition survey are shown in FIG. 9. To display the condition survey for the seller, the system first examines the Valid Inventory Properties table (shown in Section 1 of FIG. 9) for merchandise property IDs that are appropriate for the type of product the seller is listing.

Assuming a compact disc is being listed, the merchandise property ids that would be appropriate for this survey would be those found in Section 2 of FIG. 9. These merchandise properties represent questions to be asked of the seller in the survey, and are displayed in the order indicated by the DISPLAY SEQUENCE column of the merchandise properties table.

If a merchandise property is of the type “Pre-defined values”, the system uses the “Valid Merchandise Property Values” table (shown in Section 4 of FIG. 9) to determine the valid “Merchandise_Property Values” (Section 3 of FIG. 9) for the merchandise property, and displays these as answers that can be chosen by the seller for this question, displayed in the order indicated by “DISPLAY SEQUENCE” of the Merchandise Property Values. If the Merchandise Property is of the type “Boolean”, the seller may instead be presented with radio-style buttons to indicate the answer “true” or “false” (or “yes” and “no”).

A compact disc, for example, might have a survey that includes the following possible questions and answers which are referred to as “key-value pairs”:

1. What is the condition of the disc itself?

No Scratches

Some slight scratches

Significant scratches

2. Does this Compact Disc have its original liner notes (booklet insert)?

Yes

No

3. What is the condition of the CD's jewel box or case?

No Scratches

Some slight scratches

Significant scratches

Every key preferably has three possible value types: a numeric code that indicates a word or phrase that can be translated using the translation system, a free-text value entered by the seller, e.g., “32” as a value for the key “megabytes of RAM”, or a Boolean value (true-false). Every key is itself a numeric code that indicates a word or phrase that can be translated using the translation system.

For condition surveys, every value that is a Boolean or a numeric code may have a weighting associated with it, which can be either a simple number or a formula that takes into account other answers to a survey. These weightings may be used to determine the “gross” condition of a product. Advantageously, the use of weightings of the importance of specific features or specific aspects of condition to determine the “gross” condition of a product enables adjustment of the algorithm used to reflect different or changing weightings in response to changing preferences, additional data points, and the like, enabling recalculation of “gross” condition without requiring additional input from the sellers of items. Values that are free-text entries made by the seller have no weighting and are not a factor in determining an item's condition.

When the condition survey form is displayed for the seller, the system examines the list of possible key (question) items for the product group, goes to the translation system to get a translation of the key's numeric code in the language used by the seller, and then does the same for values for that key, if that value takes a numeric code as a value. If the key takes free-form text as a value, a text entry box is displayed along with the translated key, and if the key takes a Boolean value a check box or radio buttons are supplied next to the translated key. The seller may complete the survey, and the survey key-value pairs (Merchandise Property Ids and Merchandise Property Value Ids or Boolean values) are submitted to the site operator's system.

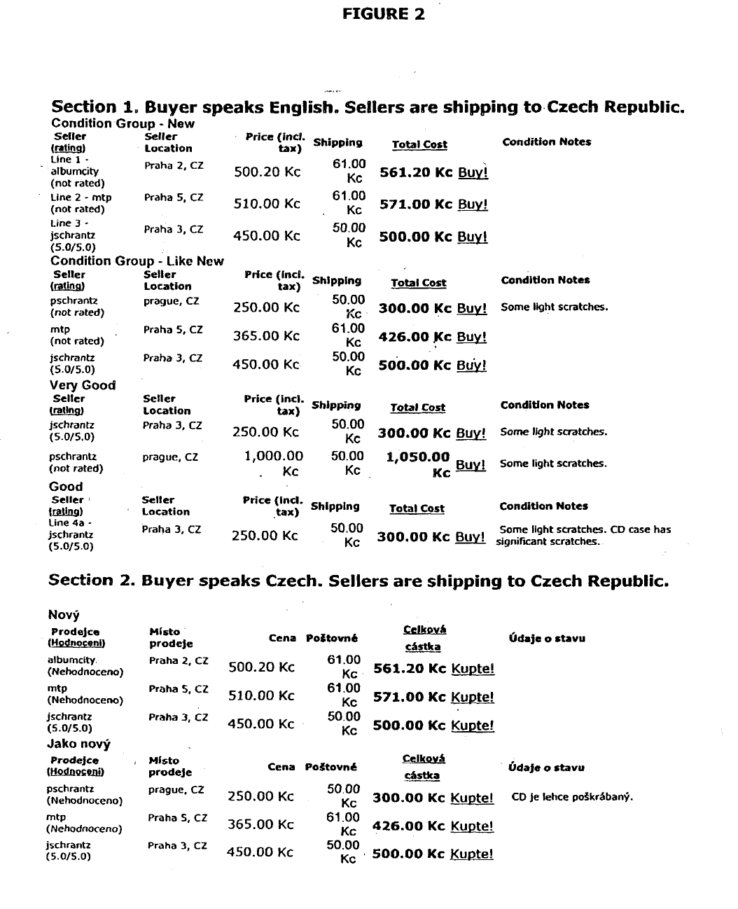

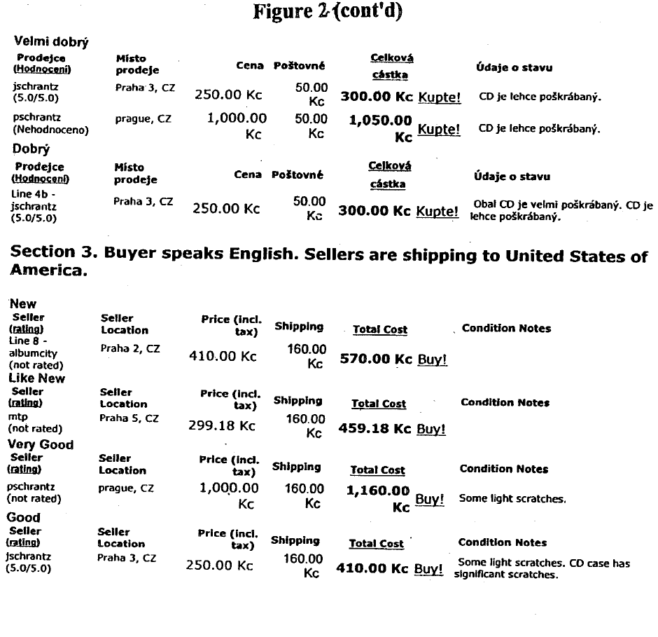

The key-value pairs may be stored with the seller's listing for this item, and the weightings may be used to calculate the condition of the item that the seller is listing on the system. Once entered, this condition information cannot be changed by the seller at a later date. This provides an audit trail for condition information that can be used should any disputes arise between buyer and seller concerning the condition of the items. An example of a sample listing of a CD by a seller, including the indication of its general condition, is shown in FIGS. 2 and 9. FIGS. 2 and 9 show one possible implementation of the language independent item condition and feature information aspects of the invention.

Referring to FIG. 9, The first section, Section 1—VALID_INVENTORY_PROPERTIES, is a join table that links keys to product groups, so that when a specific type of product is listed on the system, the system can determine the list of possible keys for that product and can thus prepare the survey for the seller.

The second section, Section 2—MERCHANDISE_PROPERTIES, is preferably a list of possible keys. The keys may have a translation entity ID as explained above, a display sequence (the order in which they will be displayed to the seller), and a property type (such as pre-defined values (numeric codes), free-text, or Boolean values.

The third section, Section 3—MERCHANDISE_PROPERTY_VALUES is preferably a list of all possible values for the keys. These values also have a translation entity ID, a display sequence (the order in which they will be displayed to the seller), and weighting to be used for determining the general condition group for a listed item.

The fourth section, Section 4—VALID_MERCHANDISE PROPERTY_VALUES, is another join table that lists the possible values for keys that take a numeric code value.

If a seller so desires, he may list items on the system through the use of a bulk upload file, which contains the UPC code or model number of the products, the price, the condition or feature numeric codes, and the maximum sales locale for the items. The system may use the UPC code or product model number to access the product catalog and produce a description of the product for display.

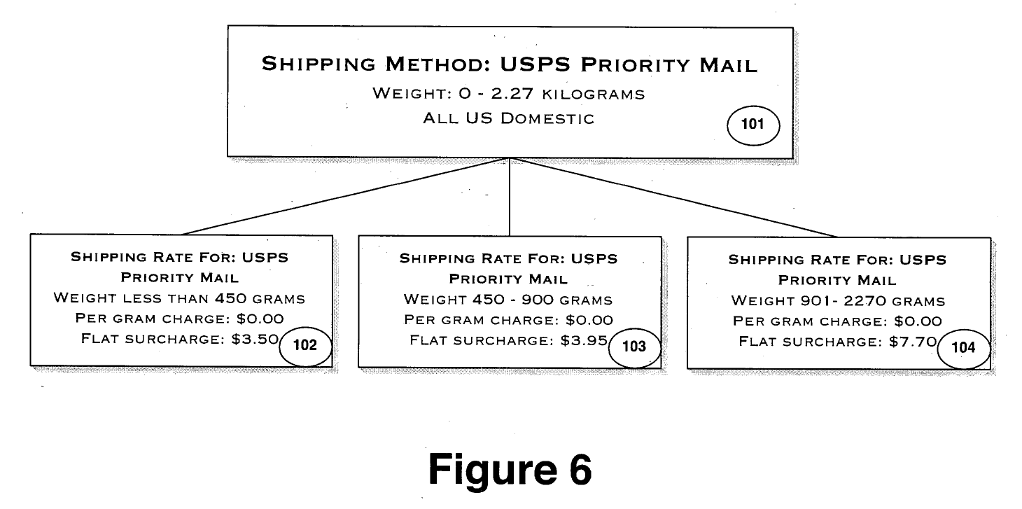

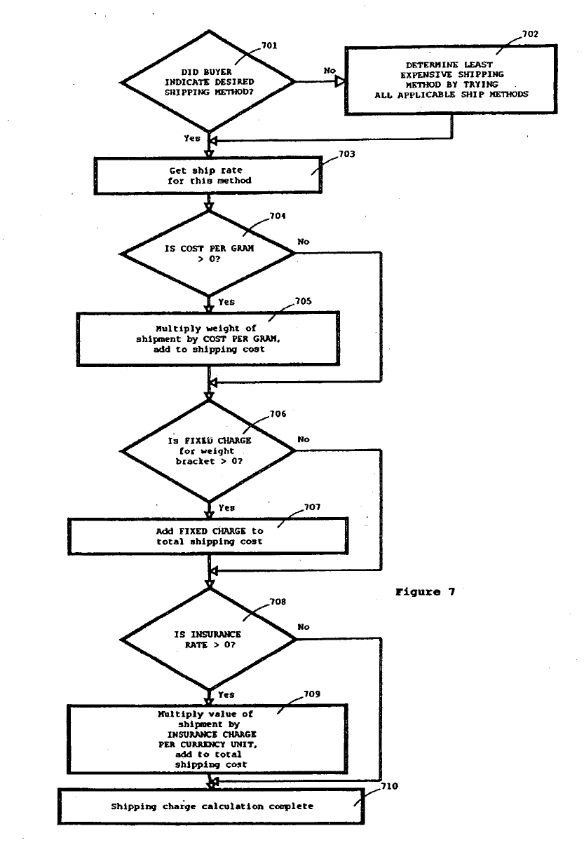

The invention also affords automatic calculation of shipping charges. Shipping charges may be calculated based on the weight of the items being shipped, the origin and destination of the shipment, the shipping method, e.g., overnight, first class, book rate, and the like, (see FIG. 6), and the value of the items being shipped.

As indicated in FIG. 6, the process for selecting a shipping method hierarchy 100 defines the various methods of shipping 102-104 that are supported by the system, and that descend from parent method 101. As shown, each shipping method may have one or more shipping rates which determine the actual charge to be applied for a chosen shipping method when taking into account the product package's weight and exact destination. An example of the relationship between shipping methods and shipping rates is shown in FIG. 6. The shipping method 101 defines a general method of shipping provided by the USPS. The shipping rates 102-104 are used to determine the actual charges for packages shipped by the selected shipping method.

Each shipping method in the system may have the following attributes:

SHIPPING METHOD NAME—the name of this shipping method.

SHIPPER NAME—the name of the carrier that provides this shipping method (e.g. US Post, Royal Mail, FedEx, UPS)

SHIPPING_METHOD_CLASS—general class for this shipping method (e.g. regular post, overnight mail, etc.)

MAXIMUM SHIP FROM LOCALE—the area in which the shipper must reside for this shipping method to be valid

MAXIMUM SHIP TO LOCALE—the area in which the recipient must reside for this shipping method to be valid

MAXIMUM SHIPMENT VALUE—the maximum shipment amount (in USD) for which this shipping method is valid. This is used to make sure that higher-value shipments do not ship by uninsured or unreliable ship methods.

MINIMUM SHIPPING_WEIGHT (GRAMS)—the minimum weight (in grams) that is supported by this shipping method

MAXIMUM SHIPPING WEIGHT (GRAMS)—the maximum weight (in grams) that is supported by this shipping method

MAXIMUM SINGLE SIDE LENGTH (CM)—the longest single dimension for a package sent by this ship method

VALID FROM DATE—the date from which this shipping method is valid

VALID TO DATE—the last date on which this shipping method will be valid

Each shipping method rate may also have a number of factors which determine the appropriate charges for that shipping method.

CURRENCY—the currency in which this shipping rate is priced

SHIPPING_METHOD—the shipping method to which a shipping rate applies

MIN_SHIPPING_WEIGHT_GRAMS—the minimum weight (in grams) that is supported by a shipping rate

MAX_SHIPPING_WEIGHT_GRAMS—the maximum weight (in grams) that is supported by shipping method

UNIT_COST_PER_GRAM_AMT—the cost per gram for shipments using a shipping rate

FIXED_SURCHARGE—the flat fee for a shipping rate

INSURANCE RATE—the cost of insuring this package, as a percentage of the product package's value

VALID_FROM_DATE—the date from which a shipping method is valid

VALID TO DATE—the last date on which a shipping method will be valid

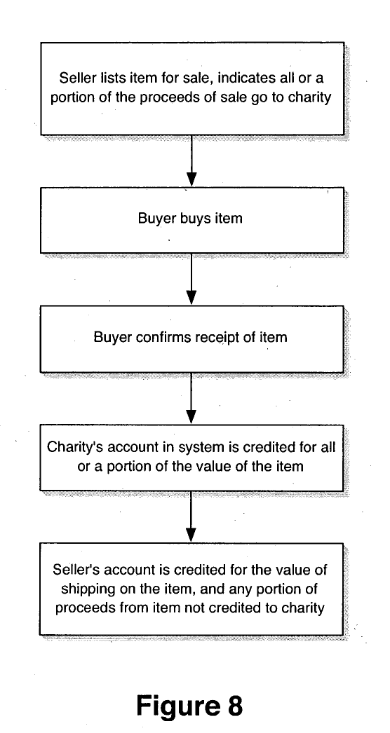

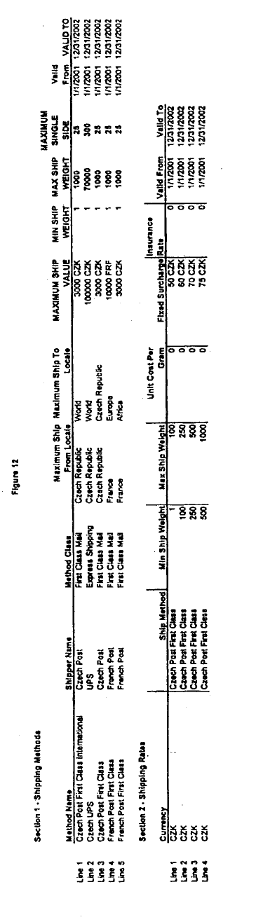

Based on these factors, a shipping rate may be calculated for every shipment in an order (individual shipments are determined by the number of different sellers represented in a buyer's order). A preferred process for the calculation of shipping charges using the foregoing attributes and factors is shown in FIG. 7. An example of a shipping calculation using the system's shipping tables can be found in FIG. 12.

Available shipping methods that may be offered by the system are shown in Section 1 of FIG. 12. Assuming that the buyer is in the Czech Republic, the seller is in the Czech Republic, and the package weighs 150 grams, the buyer would be offered the choice of choosing one of the Shipping Methods in Line 2 and Line 3 of Section 1 of FIG. 12. If the buyer chose Czech Post First Class, the system would fetch the shipping rates for that method from the system, and would display the results in Section 2 of FIG. 12.

Using the rates in Section 2 of FIG. 12, the system would determine the applicable rate for this transaction found in Line 2. The process shown in FIG. 7 may then be used to determine the applicable charge for this shipment. In step 701, the process determines whether the buyer has indicated a desired shipping method. If the buyer has not indicated a desired shipping method, the process moves to step 702 and determines the least expensive shipping method. In step 703, the process determines the shipping rate from the selected/determined shipping method. From FIG. 12, the unit cost per gram is 0 for the selected Ship Method. Therefore, at step 704, the process of FIG. 7 proceeds to step 706. (Otherwise, the process would complete step 705 by multiplying the weight of shipment by the cost per gram, and add the result to the shipping cost.) Since, the Fixed Surcharge of 60 CzK is greater than 0 (see FIG. 12), the Fixed Surcharge (60 CZK) is added to the shipping charge in step 707. The process then moves to step 708. Because the Insurance Rate shown in FIG. 12 is 0, the process skips step 709 (which would be effective to multiply the value of the shipment by the insurance charge per currency unit, and add this value to the total cost), and the shipping calculation is complete at step 710.

An analogous process can be used to determine shipping reimbursement amounts that the operator of the system will remit to sellers to offset the shipping costs. The shipping reimbursement amounts are determined in the same way as shipping charges above, but using a table with different values.

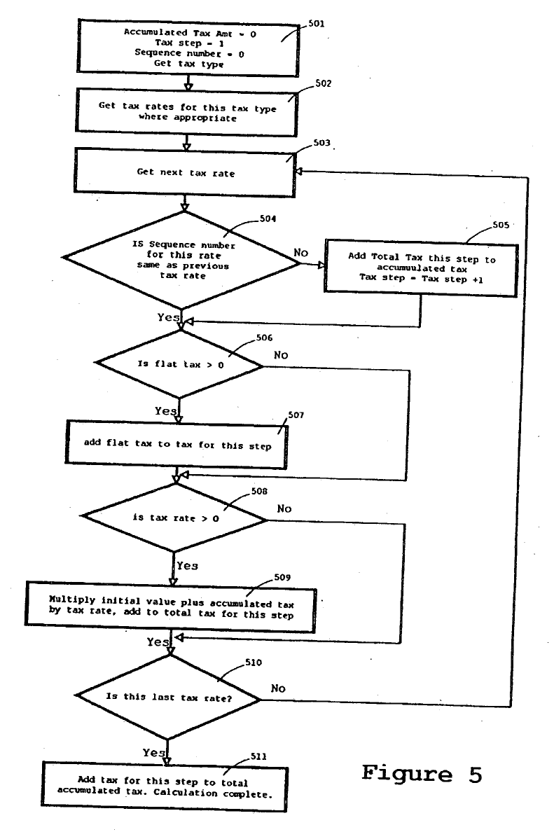

The invention also advantageously affords calculation of taxes for sales transactions. An example of this process is shown in FIG. 5.

In most countries of the world, Internet e-commerce sales transactions are not exempt from sales and luxury taxes, and so it is important for systems that mediate transactions between buyers and sellers to properly calculate tax, arrange the collection of that tax from the buyer, and arrange the pass-through or reimbursement to the seller who is responsible for paying the applicable taxes.

The method and system of the current invention contains a set of tables that allow the system to determine the tax applicable to the items in the buyer's purchase order based on an initial taxable amount, the tax status of the buyer and seller, the location of the buyer and seller, the type of goods being sold, and the sequence in which taxes should be applied, e.g., “gas guzzler” taxes may be applied before sales taxes. One embodiment of a process for calculating taxes is shown in FIG. 5.

The calculation of taxes in the system is based on the tax type being calculated, and the tax rates that apply to that tax type are based on the tax jurisdiction of the buyer and seller, and the tax-payer status of the buyer and seller. If the buyer's tax-paying status is not known (the buyer is not registered), the buyer may be assumed to be a private person. The tax type for an inventory item is determined when the item is listed, based on the condition of the item and the product group to which it belongs. The operator of the system may manage and/or maintain tax type information applicable for given shipping methods (this may be accomplished through an online query of tables which contain shipping tax rates and application rules).

Referring to FIG. 5, in the first step 501, the tax calculation step is set to 1, the accumulated tax is set to 0, and the tax types to be calculated are determined. Once the tax types have been determined, the tax rates for each tax type are retrieved from the system, and ordered by the sequence number for the tax rates (steps 502-503). Tax rates have the following attributes:

CURRENCY—the currency for this tax rate

TAX TYPE—the tax type to which this tax rate applies

MAXIMUM BUYER LOCALE—the maximum locale for the buyer, using the locale tree (see elsewhere in this document)

MAXIMUM SELLER LOCALE—the maximum locale for the seller, using the locale tree (see elsewhere in this document)

BUYER TAX PAYER STATUS—the taxpayer status (e.g. non-profit, VAT paying corporation) of the buyer

SELLER TAX PAYER STATUS—the taxpayer status (e.g. non-profit, VAT paying corporation) of the seller

FLAT TAX—the flat tax for this tax rate

PERCENT TAX—the percentage-based tax for this tax rate

SEQUENCE NUMBER—the sequence in which this tax rate should be applied to the given tax type

Once the tax rates have been determined based on a given tax type, the taxpayer status of the buyer and seller, and the location of the buyer and seller, the first tax rate may be selected based on its sequence number (step 503). If the sequence number of this tax rate is different from the sequence number of the last tax rate (step 504), then the total tax for this tax step is added to the accumulated tax and the tax step is incremented by 1 (step 505).

Next, if the flat tax for this rate is greater than zero, then the flat tax is added to the total tax for this tax step (steps 506 and 507). If the tax rate is greater than zero, then the original taxable amount plus the accumulated tax is multiplied by the tax rate, and this amount is added to the tax for this sequence (steps 508 and 509). If this is not the last tax rate, the calculation loops back to step 503. If this is the last tax rate, the tax for this step is added to the accumulated tax to complete the process (steps 510 and 511).

The method of calculating taxes can best be illustrated by offering a concrete example of the tax calculation for a single item.

This example assumes a corporate seller in the Czech Republic (“CZ”), a buyer who is a private person in the Czech Republic, and that the item being sold is a New Compact Disc with a pretax value of 500 Czech Koruna (“CZK”).

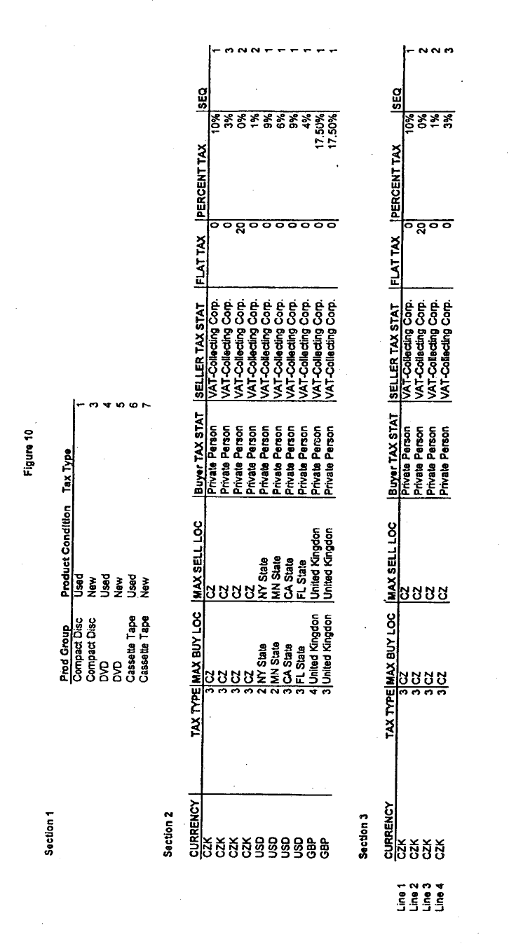

First, the system determines the tax type for the item. This may be done using tables such as those shown in FIG. 10, that provide information on taxes applicable to products. The “Tax Types” table in the system might have, in part, the entries found in Section 1 of FIG. 10. From this table, the system determines that the “Tax Type” for a new compact disc, the good being sold in this example, is “3” (Compact Disc, New). Once the system has determined the Tax Type applicable to a tax calculation, the system proceeds to the Tax Rates table to find the tax rates that apply to that Tax Type. The applicable Tax Rates are those that match the currency of the transaction, the buyer and seller's location, the tax type, and the tax status of the buyer and seller for the taxable item. A sample of the tax rates in the system is found in section 2 of FIG. 10.

After selecting the tax rates that apply to this item, the system is left with the tax rates in Section 3 of FIG. 10. These tax rates have been sorted by sequence number (“SEQ”). The system starts with the first rate (Line 1). As this is the first rate, the accumulated tax is 0 (zero), and the total tax for the current step is 0 (zero). The flat tax for this step is 0 (zero), as shown in FIG. 10, so only the percent tax (10%) applies. The system then multiplies the percent tax by the sum of the value of the item (500 CZK), plus the accumulated tax so far (0). The total tax for this step is now 50 CZK and the accumulated tax is 0.

The next tax rate (Line 2), is Sequence number 2, so the system closes sequence number 1 and adds the total tax for this step to the accumulated tax, and starts a new step. The tax for this step is now 0 CZK, and the accumulated tax is 50 CZK. The tax rate in Line 2 is flat tax 20, and the percentage tax is 0%. The system thus adds the flat tax (20) to the tax for this step.

The next tax rate (Line 3 of Section 3, FIG. 10) is also Sequence number 2, so the system does not add the tax for this step to the accumulated tax, which remains 50 CZK. The tax rate in Line 3 is a percent tax (1%), so the sum of the value of the item plus any accumulated tax is multiplied by 1%, and added to the total tax for this step. The total tax for this step is now 25.50 CZK.

The tax rate in Line 4 has Sequence Number 3, so the total tax from the current step is added to the accumulated tax, which is now 75.50 CZK, and a new tax step starts. The tax rate in Line 4 is a percent tax (3%), so the value of the item plus the accumulated tax (575.50 CZK) is multiplied by 3%, and this is added to the total tax for this step. The total tax for this step is now 17.265 CZK.

Line 4 is the last tax rate, so the total tax for this step is added to the accumulated tax (17.265 CZK+75.50 CZK=92.765 CZK). Thus, for this transaction, the correct tax for this item is 92.765 CZK, bringing the price for the item, with tax, to 592.765 CZK (which is then rounded to 592.77 CZK). Note that advantageously rounding occurs only after all taxes have been calculated.

In order to use the system, sellers must first register. In the preferred embodiment, to register as a seller, the seller must provide an operator of the system with, at a minimum, the following information: the seller's name or the name of the seller's company, the seller's desired display name (this need not be the same as the seller's name, and will be the name that buyers will see when using the system), the address from which the seller will ship the goods listed on the system, the tax status of the seller, e.g., private individual, VAT payer, non-VAT payer, or non-profit organization, the seller's tax identification, and the corporate registration numbers if that seller is registering as a corporation. Optionally, the seller can identify to the system a default geographical area as the region in which the seller wishes to sell his items.

Once the seller has provided the system with this information, the seller is registered to sell on the system. Using the seller information, the system selects the currency in which the seller will be reimbursed, as the currency used in the seller's home country, e.g., in the case of the UK, Pounds Sterling. The seller can, at his option and to the extent permitted by the operator of the system, choose to be reimbursed in a currency other than that used in the seller's home country.

Once a buyer has found a product that he is interested in purchasing, he may review all other items for sale that match that product's description by reviewing the “product detail” page. The product detail page may display basic information about the product, including, inter alia, attributes, any special features of the product and any identifying information such as UPC or model numbers, and condition information for various items that correspond to that product, all of such information may be displayed in any one of a number of languages.

To determine which items should be displayed to the buyer, the system searches through an inventory table for the identified items that have a MAXIMUM SHIP TO LOCALE that is above or equal to the locale of the buyer in the locale data structure 40 of FIG. 4, and that have an inventory item's status set to “ready for sale”. The items for sale for a given product are preferably displayed in a table to the buyer by displaying the five least expensive items in each condition group, as shown in FIG. 2 or by seller rating, or by locale as selectable by the buyer. For each item in the inventory table, the buyer may be presented with the following information:

The name of the seller selling the item

The seller's rating (as provided by buyers)

The seller's general location (city, country)

The price of the item for sale, (including any tax applicable)

The cost of shipping the item to the buyer (see FIG. 6)

The total cost of the item, shipped to the buyer

Any condition information relevant to that item, translated into the buyer's preferred language

An indicator that all or a portion of the proceeds of the sale of this item will go to a third party, including the third party's logo, if this item has been earmarked by the seller for reimbursement to a party other than the seller

All price information displayed to the buyer is converted to the buyer's preferred currency (in the example of FIG. 2, Czech Koruna), which may not be the same currency as that in which the seller will be reimbursed for the sale of those items. The condition information to be displayed is based on the key-value pairs describing condition that were input by the seller in structured, language-independent format when the seller listed the product for sale, as described above.

FIG. 2 is an example of a possible display of an available inventory of items that may be provided to buyers by the invention. The example is for buyers who speak English or Czech, and where shipments are to the Czech Republic and the United States. FIG. 2 has three sections, showing the display information that would be presented to a buyer based on three different sets of conditions. In Section 1, the buyer speaks English and the seller is shipping to the Czech Republic. In Section 2, the buyer speaks Czech and the seller is shipping to the Czech Republic. In Section 3, the buyer speaks English and the seller is shipping to the United States of America. All sellers shown in FIG. 2 are assumed to be located in the Czech Republic.

In Section 1 of FIG. 2, the display information for items corresponding to Product #254741 is shown. This display information assumes the buyer speaks English, and that the seller will be shipping to the Czech Republic. Line 1 of Section 1 (seller “AlbumCity”) shows the results of the calculations performed by the system for a seller that collects sales tax on his sales (see FIG. 5), and is selling into a jurisdiction that requires that the seller collect taxes from the buyer. Because this seller registered with the system as a tax collecting entity in the Czech Republic, and this seller is shipping to the Czech Republic, the system has tax added to the prices displayed to the buyer. The shipping charges collected by the seller also have sales tax added.

The price shown for the listing in Line 3 of Section 1 does not have sales tax applied because in this instance the seller is an non-tax collecting individual (“jschrantz”). Also, the 50 Kc shipping charge is the same charge as for the method of shipping in Line 1 where the charge is shown as 61.00 Kc, but without the tax applied to shipping as it is in Line 1. This is because the seller “jschrantz” is an individual and does not collect sales tax on the sale of goods or shipping.

Section 2 of FIG. 2 represents the same display information as that shown in Section 1, with the important distinction that the display information is in the Czech language and would be shown to a buyer with a preferred display language of Czech. The preferred language for a buyer is determined at the time of registration, or if this is the first visit to the site by a new buyer, by making assumptions based on the host address locale of the buyer. The buyer is free at any time to change his preferred display language. Thus, the condition information that was provided by the seller in English in Section 1 has been converted to Czech in Section 2, as shown.

In Section 3 (Buyer Speaks English and the Seller is Shipping to the United States), the number of product items being displayed for sale to the buyer has changed, and the tax and shipping calculations have changed as well, reflecting the buyer's location in the US. A number of the product items that were available for sale to buyers in the Czech Republic are not available to a buyer in the United States in this example. For example, the item that is for sale on Line 2 of Section 1 is no longer displayed to the buyer in the US, because the maximum sales locale for that item does not include the US. A seller might choose to make his items available only in the seller's home country or in a specific region, as the seller in Line 2 has, or might be restricted by contract or by law from selling outside a certain geographical area.

The location of the buyer in the US has other effects on the display of items to the buyer. Shipping charges have increased, but taxation is no longer included, because export sales by Czech sellers do not include tax.

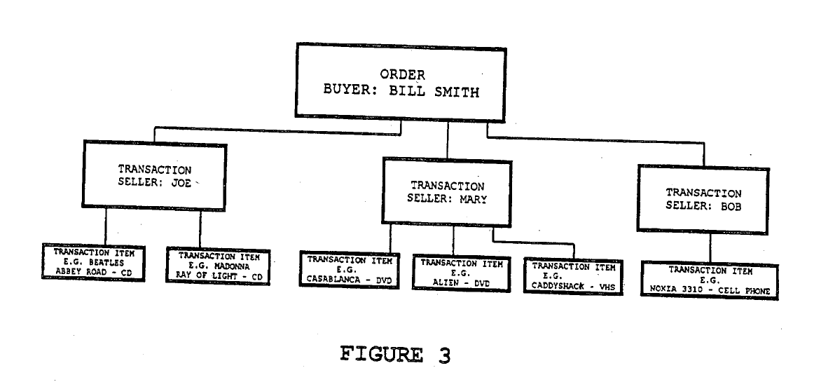

Every order in the system is divided into order transactions. An order transaction is a grouping of items in a buyer's order by seller. There are two currencies associated with each order transaction (the currency in which the buyer will pay for this order transaction, and the currency in which the seller will be reimbursed for these items). There is a shipping method associated with each order transaction. An example of the relationship between an order (from buyer “Bill Smith” to sellers “Joe”, “Mary” and “Bob”) and order transactions is shown in FIG. 3.

When a buyer has chosen the items he wishes to buy in a shopping session, he is directed to the checkout procedure. The first step in the checkout procedure is for the buyer to select a payment method. The payment method selected by the buyer determines the currencies in which it will be possible to pay for the order. Although the buyer may have been using the system up to that point with a different “default display currency”, it might not be possible to pay in that currency for the order if the buyer has selected a payment method that does not support the buyer's default display currency. Once the buyer has selected a payment method, the buyer may select the currency in which the buyer would like to pay for the order, or the system may determine a default method. If the buyer selects a payment method, and does not want to pay in any of the currencies supported by that payment method, the buyer is asked to select a different payment method.

Secondly, the buyer is asked to select a shipping address for the items in the order. This can be chosen from a list of addresses the buyer has used in the past, or the buyer can enter a new address.

Thirdly, based on the shipping address the buyer has selected, the buyer is presented with the available shipping methods for the “order transactions” in the order (see FIG. 7). For each “order transaction” in the order, the buyer either accepts the default shipping method, or selects one of the other available shipping methods for that order transaction.

Once the buyer has selected a payment method, a shipping address, and has chosen shipping methods for each of the order transactions in the order, the tax and shipping charges for the order are recalculated. All amounts in the buyer's order are converted to the buyer's preferred payment currency. This is for payment purposes only; the seller will be reimbursed for his goods in his preferred currency. The buyer is then presented with the initial order total. The total value of the items in the buyer's order at the time of checkout, including any applicable tax and shipping charges, is the buyer's initial order total.

If the buyer accepts the initial order total, and chooses to pay for the items in the order, the buyer is asked to enter his payment details. The buyer's order is placed in a waiting for payment status.

If the payment method does not require re-directing the buyer to the payment provider's system, the buyer is asked to enter his payment details (e.g. credit card details, bank acct. details, and the like), and these may be stored with the buyer's order. These details may be used after the buyer completes checkout to complete the payment process for the order.

If the payment method chosen by the buyer is a “capture only” payment method that requires re-directing the buyer to his payment provider's system, the buyer is redirected from the operator's system to a system maintained by the payment provider. The buyer enters his payment details on the payment provider's site, and then is redirected back to the service.

If the payment provider does not redirect to the service, or the service is not able to determine if the capture of funds was successful, the order may be cancelled, and the buyer may be notified of that fact in the buyer's preferred language.

If the payment method chosen by the buyer is an “Authorization and Capture” payment method, e.g., VISA, MasterCard, or American Express, an attempt is made to receive authorization for payment in the amount of the initial order total. If authorization is successful, the buyer's order is placed in a payment authorized status. If authorization is unsuccessful, the order is placed in cancelled status, and the buyer is sent a notification in the buyer's preferred language that the payment was not authorized, and that the order has been cancelled. When the order is cancelled, the items in the buyer's order are returned to available inventory and can be purchased by other buyers.

As soon as the buyer has completed the checkout procedure, the seller(s) of the items in the buyer's order may receive from the system a confirmation of availability (“COA”) e-mail in the sellers' native language(s). For every item in the buyer's order, the seller of that item may confirm to the operator of the service that the seller has the item and is ready to ship it within a particular time period, e.g., two business days. In addition to the COA e-mail, the seller is preferably provided with a batch file of that day's new orders that can be imported into the seller's own logistics system.

If the seller confirms that the seller has an item in the buyer's order, the status of the item in the buyer's order is changed to confirmed availability. If the seller of an item explicitly rejects the COA on the grounds that the seller is unable or unwilling to ship the item to the buyer, the item is cancelled from the buyer's order, and the buyer is notified in the buyer's preferred language that one of the items in that order will not ship.

Two business days from the time of checkout, all items in the buyer's order to which the seller has not responded in any way to a COA may be cancelled from the buyer's order, and the buyer's order may be recalculated using those items that are in a confirmed availability status. Only the items in confirmed availability status constitute the buyer's final order. The items in the final order are used to calculate the final order total, which includes tax and shipping on those items. All amounts in the buyer's order are converted to the currency in which the buyer chose to pay in the checkout step.

Once the final order total has been determined, this amount is charged to the buyer using the payment method that the buyer chose in the checkout step. If the payment method chosen by the buyer required pre-payment, i.e., the payment method chosen was a capture only payment method, and the initial order total exceeds the final order total, the buyer is credited for the difference between the final order total and the initial order total.

Once the final order total has been determined, the sellers of each remaining order transaction in the order may each be sent an e-mail by the system (in the respective seller's preferred language) with the details of the items in the buyer's order that will be shipped by that seller, and the shipping method chosen by the buyer for those items. The seller may be expected to ship the items within a fixed period of time (e.g. two business days) of receiving the shipping instructions. For each shipping method, there may be an associated estimated shipping time. After a fixed period of time set by the operator of the system (e.g. 10 business days) plus the estimated shipping time has elapsed, the buyer may be sent (normally by e-mail) a request (in the buyer's preferred language) to confirm having received the items in each of the buyer's order transactions.

If the buyer confirms having received the items in a particular order transaction (either affirmatively or by the absence of a complaint within a fixed period of time), the seller of those items is credited for the value of the items in the transaction, any tax that applied to those items, the shipping amount, and any tax that applied to the shipping. From this amount, the service may subtract a commission on the sale of items, and a commission on the seller's shipping fee reimbursement. All of these credits are in the seller's preferred currency and are credited to the seller's account in the system. The buyer is asked to rate his experience with the seller using a structured survey similar to the survey used in listing an item for sale using the web interface. The seller rating survey may include an overall rating question with pre-defined answers, one or more specific questions about the transaction itself (preferably with pre-defined answers), and optionally a free form text field for additional language specific comments. A buyer's responses to these structured questions about a transaction with a given seller are converted to a series of numbers and weighting codes and are stored in a database, that can then be used to display this rating information and specific transaction performance metrics in different languages, including a prospective buyer's preferred language. The display of the answers to specific questions about the performance of a seller on previous transactions, can provide a prospective buyer with a much more complete an easily understandable picture of the nature of such a given seller. For example, if the seller feedback questions included questions about the timeliness of shipping, price, accuracy of condition information, and quality of packaging, a prospective buyer would be able to make a more informed decision. For example, seeing that 42% of respondents said the seller “shipped within 2 days”, 88% of respondents “were pleased with the price paid”, 93% of respondents said the seller's “items were in the same or better condition than described”, and 78% of respondents said the quality of the packaging was “very good,” a buyer might decide that he values price, reliability of the condition and packaging more than fast shipping and could chose to do business with this seller despite a lower “gross” or overall feedback rating than another seller. Importantly, the ability to collect this structured specific information enables a buyer to establish trust in a seller despite not sharing a language or being able to communicate directly.

If the buyer responds that he did not receive one or more of the items in his order, the seller of that item may be notified in his preferred language by an automated communication (e.g. an e-mail) that the buyer has not yet received the item, and may be asked to confirm that the item did in fact ship, and to provide a shipping number for that item. The communication (an e-mail) received by the seller is preferably in a standardized form that can be machine-processed by the seller if he so desires, and the response to such a communication is preferably from a pre-defined set of responses and can be machine-interpreted by the system. If the seller confirms that the item did in fact ship, the buyer may be notified in the buyer's preferred language that the item did in fact ship, and may be asked to wait an additional fixed period of time (e.g. five business days) for the item to arrive. After an additional fixed period of time (e.g. five business days) has elapsed, the buyer may again be sent a request (in the buyer's preferred language) by the system to confirm that the item has arrived. If the buyer at this point does not confirm that he has received the item(s), either the system initiates a rule-based automated dispute resolution system by sending each party automated emails in the respective preferred languages, or the customer support provided by the system may intervene to resolve the dispute.

On a schedule set by the operator of the system, payment is made to the seller for all the credits accumulated by the seller in his account since last payment. These payments are made only when the seller has accumulated enough credit to exceed the minimum payment amount as determined by the operator or on a predetermined schedule as determined by the operator. Payment can be made to the seller by check, wire transfer, credit card, and by other methods. Whether the seller has accumulated enough credit to exceed the minimum payment amount or not, the seller can at any time choose to accept payment for accumulated credit by store credit or by gift certificate.

While the foregoing has described the invention with reference to particular preferred embodiments, it will be appreciated by those skilled in the art that changes in these embodiments may be made without departing from the principles and the spirit of the invention, as set forth in the language of the following claims and their legal equivalents.

What is claimed is:

1. A network-based system for executing transactions between sellers and buyers for the sale of items, the system comprising:
a first portion for receiving item information from a seller regarding an item offered for sale in any one of a plurality of different languages selected by the seller;
a second portion for providing the item information to a buyer in any one of a plurality of different languages selected by the buyer; and
a third portion for receiving payment information for the item from a buyer in any one of a plurality of different currencies selected by the buyer, and for facilitating payment to the seller in any one of a plurality of currencies selected by the seller.

2. The system of claim 1 further comprising:
a fourth portion for facilitating communication between the buyer in any one of a plurality of different languages selected by the buyer and the seller in any one of a plurality of different languages selected by the seller for the purpose of communicating about a transaction.

3. The system of claim 1 further comprising:
a seller-ratings portion for receiving transaction performance information from a buyer regarding the performance of a seller in a transaction in any one of a plurality of different languages selected by the buyer, and for providing historical performance information about a seller to the buyer in any one of a plurality of different languages selected by the buyer.

4. The system of claim 1 wherein the first, second, and third portions are implemented over a computer network using at least one Web site interface.

5. The system of claim 1 wherein the system is further adapted to receive tax information from the seller and buyer, and to automatically calculate tax due to the seller, based at least in part on the received tax information, and to facilitate payment of tax due to the seller from the buyer.

6. The system of claim 5 wherein the tax information comprises a tax status of the seller, a shipping address from which the seller will ship the product, a tax status of the buyer, and a shipping address of the buyer.

7. The system of claim 1 wherein the system is further adapted to receive shipping information from the seller and the buyer, and to automatically calculate shipping charges, based at least in part on the shipping information.

8. The system of claim 1 wherein the item information comprises a price of the item in any one of a plurality of currencies selected by the seller, and wherein the system is adapted to automatically convert the price into any one of a plurality of currencies selected by the buyer, and wherein the second portion displays to the buyer the price of the item in the currency selected by the buyer.

9. The system of claim 1 wherein the item information comprises at least one parameter selected from the group consisting of size, type, weight, price, and condition of the item.

10. The system of claim 1 wherein the item information comprises characteristics information regarding the characteristics of an item, and wherein the system is adapted to convert the characteristics information to a code number that can be stored in a database and is used to translate and display the characteristics information in natural language form in a plurality of different languages.

11. The system of claim 10 wherein the characteristics information for an item may be entered by in any one of a plurality of different languages by completing a questionnaire containing predefined data entry fields.

12. The system of claim 10 wherein the characteristics information stored in code number format is used by the system to enable a user of the system to search in a plurality of different languages for items having certain characteristics.

13. The system of claim 10 wherein the characteristics information stored in code number format is processed by at least one algorithm stored within the system, the algorithm being adapted to apply weightings for the characteristics information to determine a category to which an item belongs and to enable the system to display category information for an item in natural language form in a plurality of different languages.

14. The system of claim 13 wherein an operator of the system is able to adjust the weightings to the characteristics information stored in code number format and to add additional weightings and characteristics information to the at least one algorithm and to enable the system to display the additional information in natural language form in a plurality of different languages.

15. The system of claim 1 wherein the payment information comprises payment options including at least one of the options selected from the group consisting of electronic payment, cash payment, credit card payment, and check payment.

16. The system of claim 15 wherein the third portion is further adapted to transfer funds from the buyer to the seller for the item sold.

17. The system of claim 2 wherein the system enables transaction specific communication between the buyer in any one of a plurality of different languages selected by the buyer and the seller in any one of a plurality of different languages selected by the seller through the use of structured communications which contain predefined fields, the responses to which are converted to code numbers that can be stored in a database and used to translate and display structured communications corresponding to the predefined fields in natural language form in a plurality of different languages.

18. The system of claim 17 wherein predefined response information stored in code number format is used by the system to initiate structured communication to a responding party in any one of a plurality of different languages based at least in part on a rule set for interpreting the codes and initiating the structured communication.

19. The system of claim 3 wherein the transaction performance information comprises information entered in any one of a plurality of different languages as at least one response by a buyer to a structured questionnaire containing predefined fields, and wherein the system is adapted to convert the transaction performance information to code numbers that can be stored in a database and used to translate and display the transaction performance information in natural language form in a plurality of different languages.

20. The system of claim 19 wherein the transaction performance information stored in code number format is used by the system to enable a user of the system to search for sellers based on transaction performance information in a plurality of different languages.

21. The system of claim 19 wherein the transaction performance information stored in code number format is processed by at least one algorithm that applies weightings to the transaction performance information to determine a category to which a seller belongs and to enable the system to display the category of a seller in natural language form in a plurality of different languages.

22. The system of claim 21 wherein an operator of the system is able to adjust the weightings of the transaction performance information stored in code number format and add additional weightings and transaction performance information to the at least one algorithm to determine the category to which a seller belongs and to enable the system to display the additional information in natural language form in a plurality of different languages.

23. A method for executing transactions between sellers and buyers for the sale of products, the method comprising the steps of:
receiving product information from a seller regarding an item offered for sale in any one of a plurality of different languages selected by the seller;
providing the item information to a buyer in any one of a plurality of different languages selected by the buyer;
receiving payment information for the item from the buyer in any one of a plurality of different currencies selected by the buyer; and
facilitating payment to the seller in any one of a plurality of currencies selected by the seller.

24. The method of claim 23 further comprising the step of:
facilitating communication between the buyer in any one of a plurality of different languages selected by the buyer and the seller in any one of a plurality of different languages selected by the seller for the purpose of communicating about a transaction.

25. The method of claim 23 further comprising the steps of:
receiving transaction performance information from a buyer regarding the performance of a seller in a transaction in any one of a plurality of different languages selected by the buyer; and
providing historical performance information about a seller to the buyer in any one of a plurality of different languages selected by the buyer.

26. The method of claim 25 wherein each of the steps is performed over a computer network.

27. The method of claim 23 further comprising the steps of:
receiving tax information from the seller and buyer;
automatically calculating tax due to the seller, based on the received tax information; and
facilitating payment of the tax due to the seller from the buyer.

28. The method of claim 27 wherein the tax information comprises a tax status of the seller, a shipping address from which the seller will ship the product, a tax status of the buyer, and a shipping address of the buyer.

29. The method of claim 23 further comprising the steps of:
receiving shipping information from the seller and the buyer; and
automatically calculating shipping charges based on the shipping information.

30. The method of claim 23 wherein the item information comprises a price of the item in any one of a plurality of currencies selected by the seller, and further comprising the steps of:
automatically converting the price into any one of a plurality of currencies selected by the buyer; and
displaying to the buyer the price of the item in the currency selected by the buyer.

31. The method of claim 23 wherein the item information comprises at least one parameter selected from the group consisting of size, type, weight, price, and condition of the item.

32. The method of claim 23 wherein the item information comprises characteristics information regarding the characteristics of an item, and wherein the method converts the characteristics information to a code number that can be stored in a database and is used to translate and display the characteristics information in natural language form in a plurality of different languages.

33. The method of claim 11 wherein the payment information comprises payment options including at least one of the options selected from the group consisting of electronic payment, cash payment, credit card payment, and check payment.

34. The method of claim 33 further comprising the step of:
transferring funds from the buyer to the seller for the item sold.
